(19) United States
(12) Patent Application Publication
(10) Pub. No.: US 2022/0355906 A1
(43) Pub. Date: Nov. 10, 2022

(54) Enhanced Kiteboarding System

(71) Applicants: Ryan Mitchell, Fleming Island, FL (US); Chris Tanner, Live Oak, FL (US)

(72) Inventors: Ryan Mitchell, Fleming Island, FL (US); Chris Tanner, Live Oak, FL (US)

(21) Appl. No.: 17/871,955

(22) Filed: Jul. 24, 2022

(51) Int. Cl. B63B 32/59; B63B 32/50; B63B 32/40; B63B 32/77

(52) U.S. Cl. CPC B63B 32/59; B63B 32/50; B63B 32/45; B63B 32/77; H04W 4/80

(57) ABSTRACT

An enhanced kiteboarding system is disclosed, combining at least a footboard and a kiteboard. The footboard has a protruding ridge incorporated therein, and also has one or more BTLE-grain(s) embedded therein. The footboard may also have a safety beacon embedded therein. The user operating the kiteboard system can be equipped with a variety of body-wearable mechanisms, such as wrist-wearable(s), body-wearable(s), and ankle-wearable(s) that communicate with the BTLE grains, as well as other communication products. The BTLE-grains can be located near to the protruding ridge within the footboard, or in a separate location within the footboard. A method of manufacture and method of testing are also disclosed.

### BACKGROUND OF THE INVENTION

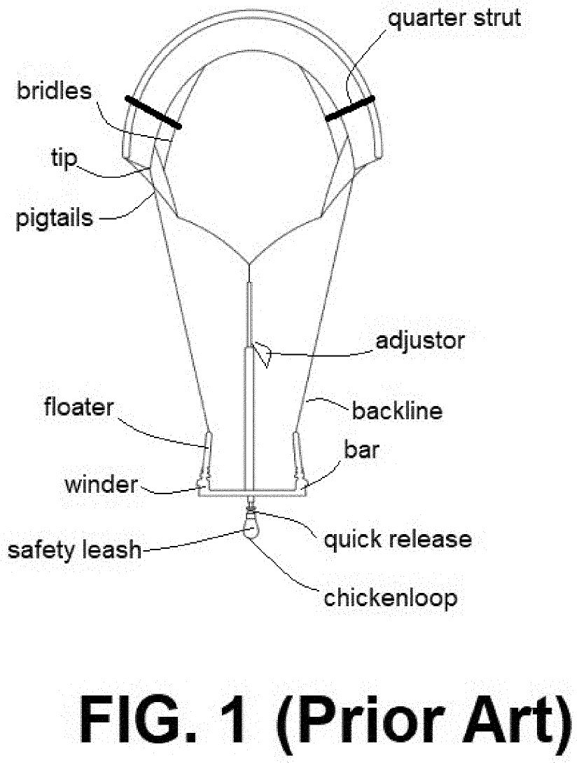

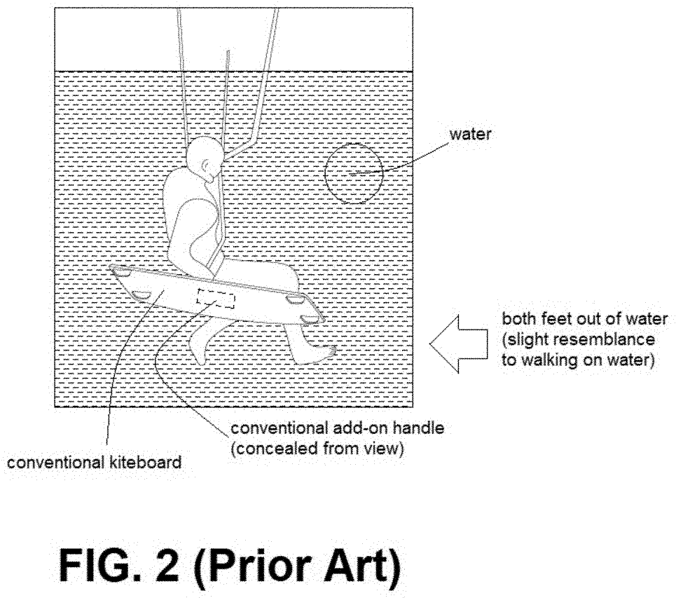

FIG. 1 (Prior Art) shows a conventional kiteboard arrangement. FIG. 2 (Prior Art) shows a kiteboarder doing a specific type of trick, a type of walking on water, known as a “Jesus Walk”.

A semantic issue within this disclosure is first noticed in FIGS. 1-2. In conventional conversational usage, a “kiteboard” may refer to an entire arrangement including a board itself where the user's feet are located; cables; operation-bar; and the kite itself.

However, within this disclosure, such conventional word-usage is not possible, as doing so would be misleading. To remove any ambiguity, within this disclosure the board-section where human feet are located is referred to as a “footboard”, even though most people would call this the “kiteboard”. The term “waterboard” is pretty much out, let's not use that expression even though it's arguably the most accurate. Applicant merely wishes to note that the board-component is only one part of a larger mechanism comprising a kiteboarding experience.

As such, the expression “footboard” provides greater clarity, and will be used herein.

During a typical kiteboarding experience, it's almost always a bad idea to let go of the kite-handle for any length of time. The kiteboarding experience will quickly become a swimming-only experience. Thus, during a Jesus Walk, the boarder must still use one hand to hold the bar. The bar that has the 4 kite-wires attached. A kiteboarder typically will not remove both hands from this bar, or does so only for short times.

As such, during tricks, such as a “Jesus Walk”, the kiteboarder would be holding both the board and the kite-handle, where each grip requires an entire hand to be effective. As such, a key risk within some tricks, is losing control of the footboard. Many tricks require full use of and grip on the kite-handle. That only leaves one hand to hold the footboard. As such, tricks could result in losing the footboard entirely. This is another quick way to change the kiteboarding experience into a swimming-only experience.

### DETAILED DESCRIPTION OF THE DRAWINGS

FIG. 1 shows a conventional kiteboard arrangement;

FIG. 2 shows a kiteboarder doing a specific type of trick;

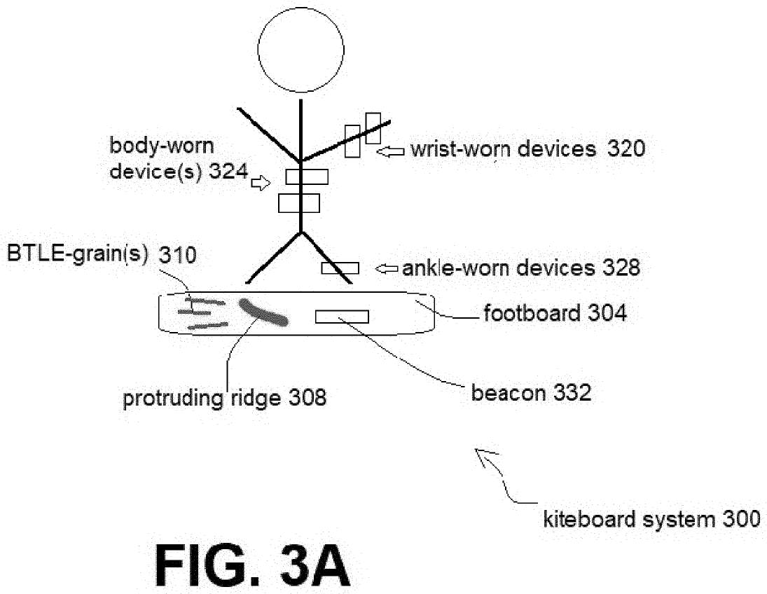

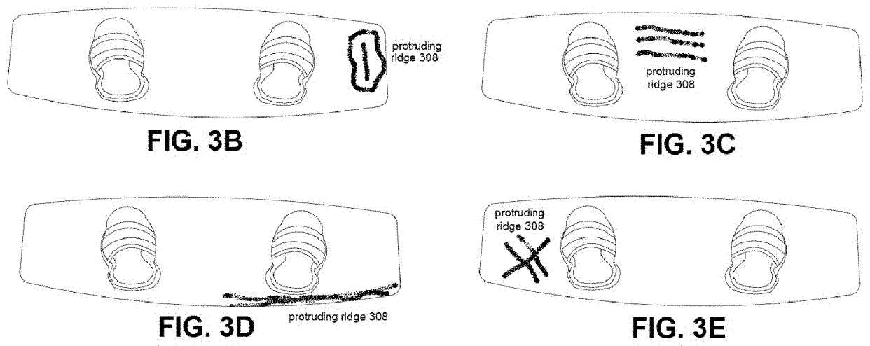

FIG. 3A shows a footboard having a protruding ridge incorporated therein;

FIGS. 3B-3C-3D-3E show example non-limiting positions of the protruding ridge;

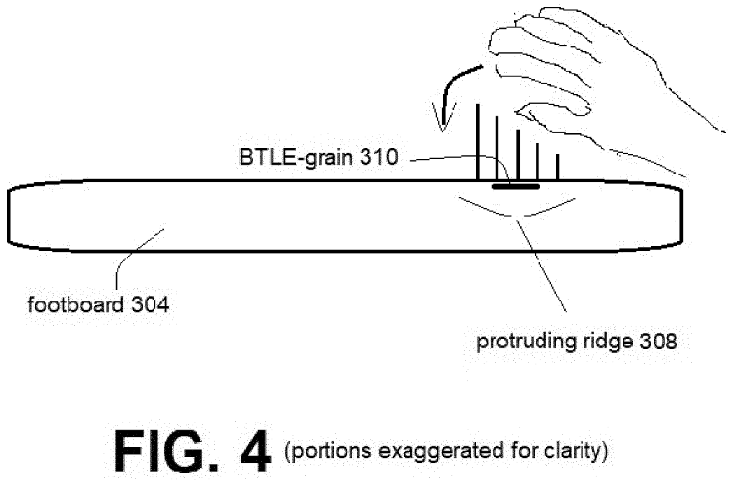

FIG. 4 shows a footboard in profile view, illustrating an optimal contour of the protruding ridge;

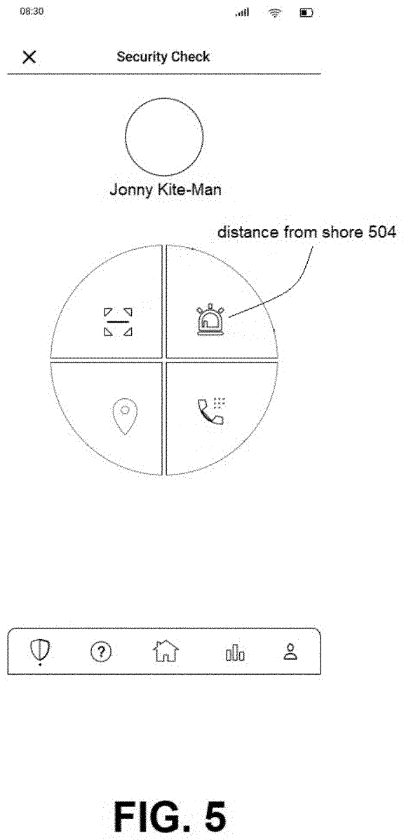

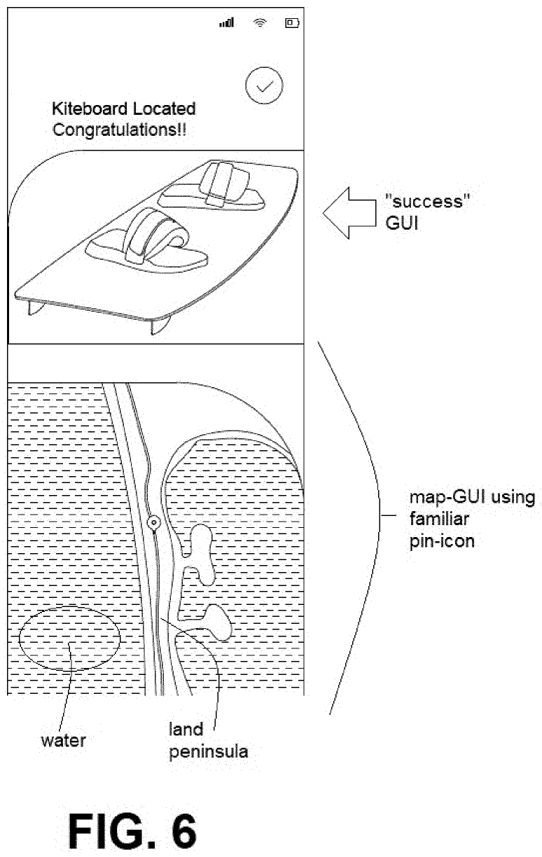

FIGS. 5 and 6 show example GUIs for an Apple Watch application for use with the embodiments herein;

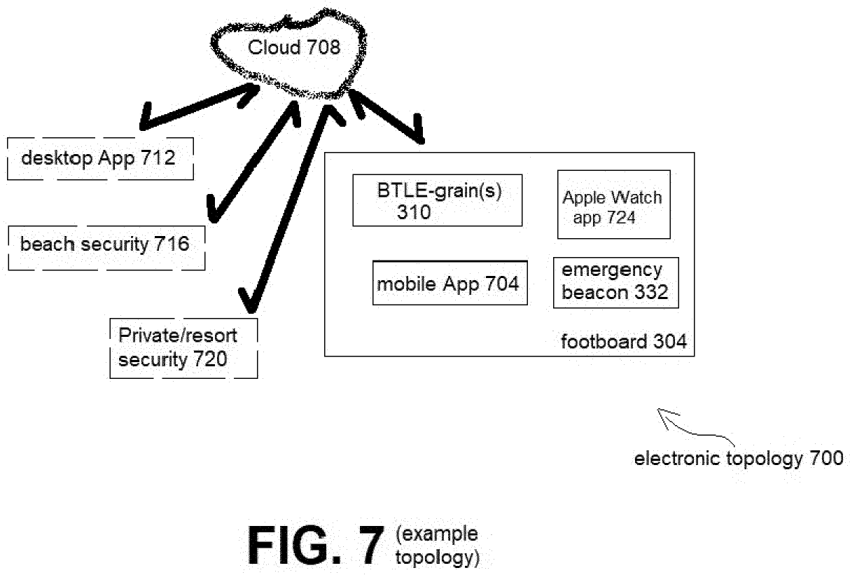

FIG. 7 shows an example suggested network\electronic topology for various of the IT components associated with the embodiments herein;

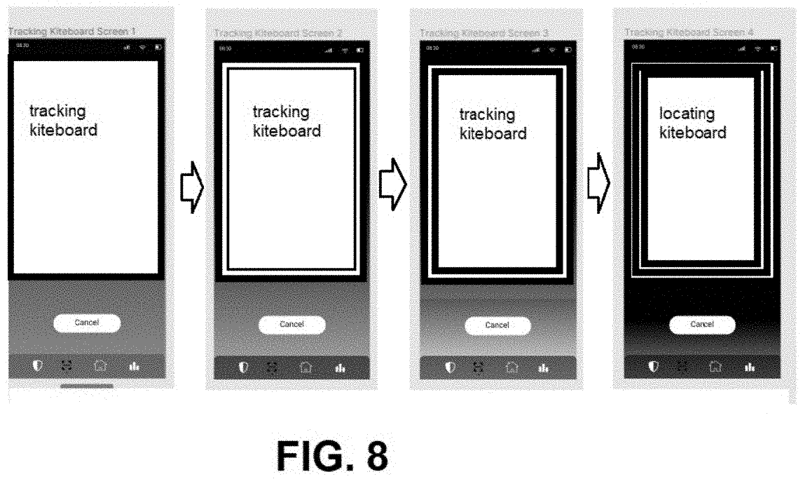

FIG. 8 shows an example four-screen-sequence on the Apple Watch app when the network topology is searching for a lost or missing footboard;

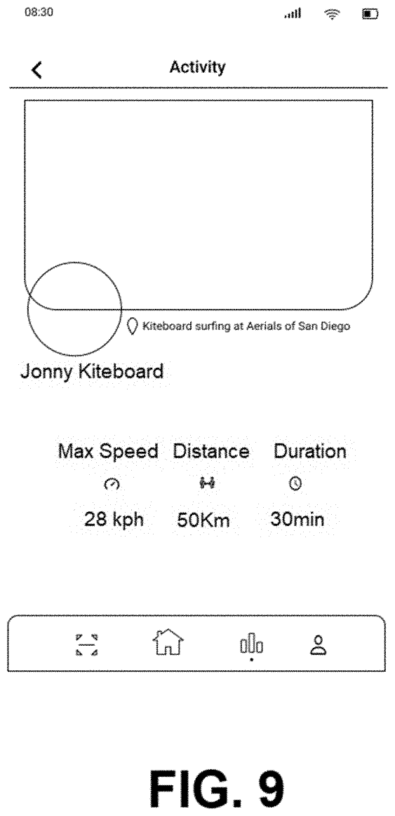

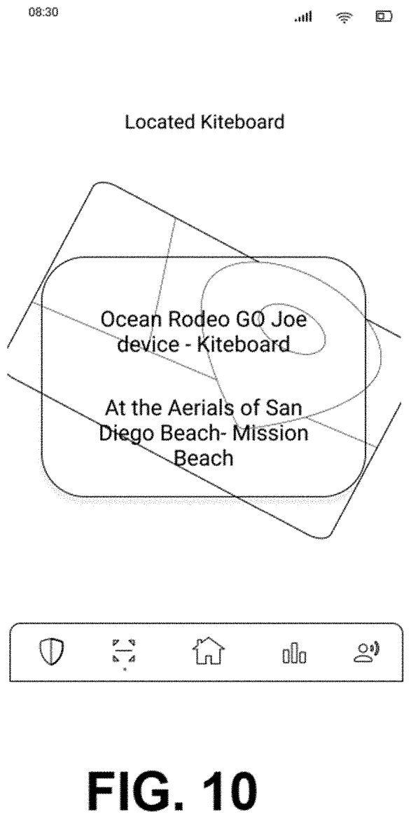

FIGS. 9 and 10 shows example GUIs to be displayed on the mobile app;

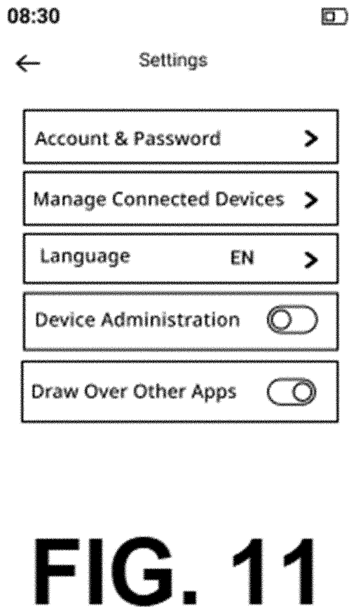

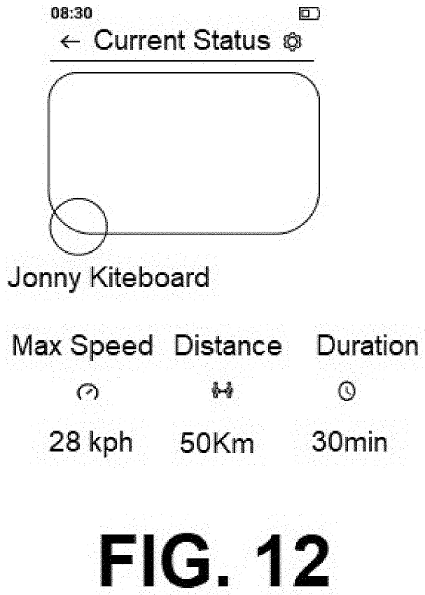

FIGS. 11 and 12 show additional example Apple Watch GUIs;

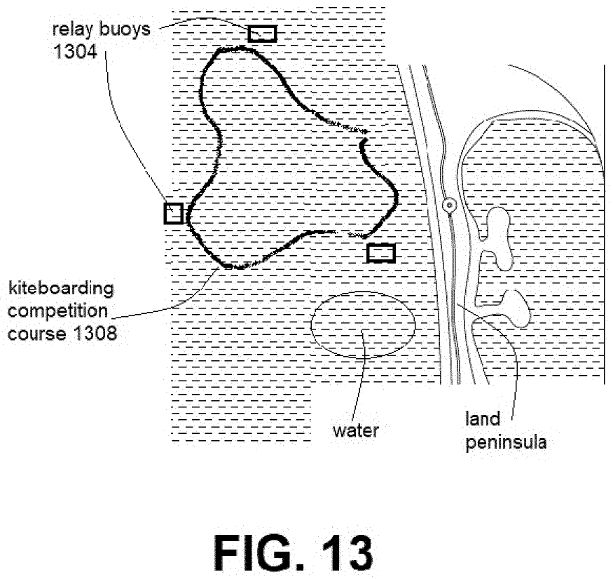

FIG. 13 shows a racing course having relay buoys;

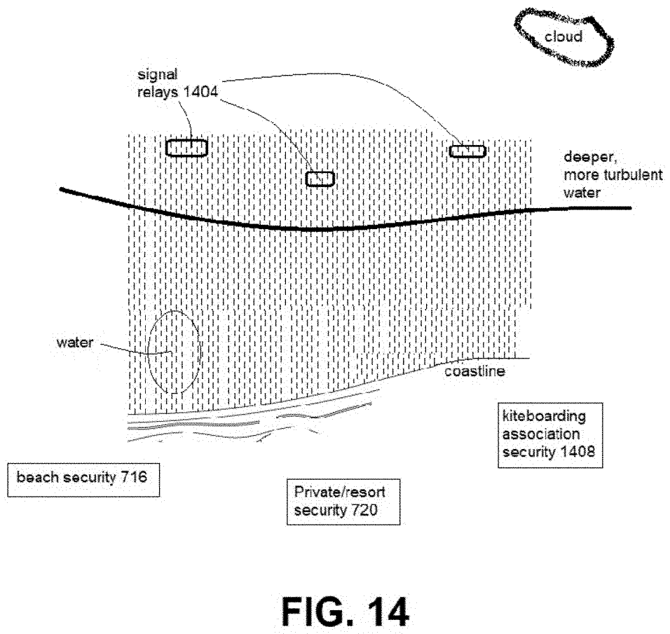

FIG. 14 shows an environment far from shore used by more experienced kiteboarders seeking a more challenging and more difficult experience;

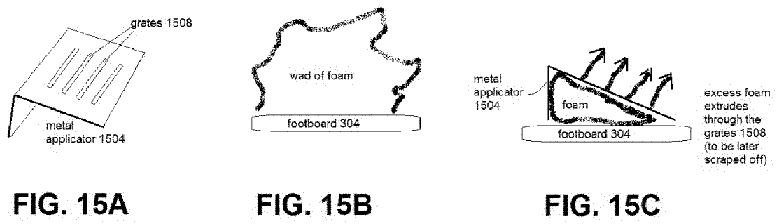

FIGS. 15A-15B-15C show a custom metal applicator having grates as a way of applying slow-hardening foam, where that foam is shaped into a protruding ridge;

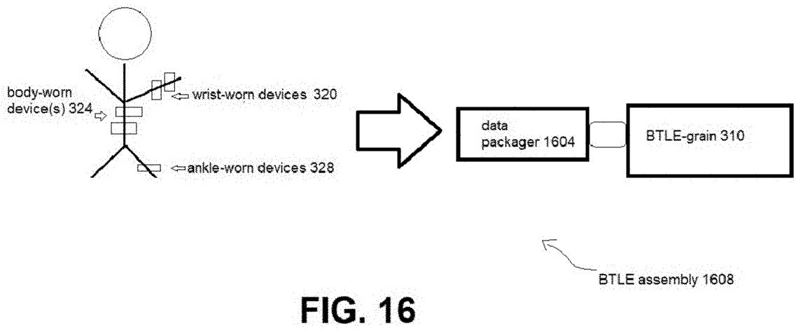

FIG. 16 shows an embodiment of a BTLE-assembly having a data-packager.

### DETAILED DESCRIPTION OF PREFERRED EMBODIMENTS

FIG. 3A shows a footboard 304 having a protruding ridge 308 incorporated therein. The footboard 304 also comprises one or more BTLE-grain(s) 310, and may also have a safety beacon 332. The kiteboarder can be equipped with a variety of body-wearable mechanisms, such as wrist-wearable(s) 320, body-wearable(s) 324, and ankle-wearable (2) 328.

FIGS. 3B-3C-3D-3E show example non-limiting positions of the protruding ridge 308.

### Word-Usage and Semantics

Some kiteboarders who do “Jesus Walk” or other tricks may sometimes refer to the protruding ridge 308 described herein as a “trick handle” or “grab handle”. Such usage is not possible within this patent disclosure, first because many kiteboards are adapted to have an aftermarket handle. The protruding ridge 308 is not one of these, and has many non-handle features. To avoid confusion, this disclosure will refer to a protruding ridge 308, although conventional usage may still refer to it a trick handle or grab handle, inaccurate as that may be.

Second, it may be possible to refer to the protruding ridge 308 as a “handle”, and this would have some accuracy, yes still be somewhat misleading. The protruding ridge 308 has some handle-like properties, yes, but more importantly acts as a softer almost foam-like piece that either attaches or is molded/machined into the top surface of the footboard 304. The protruding ridge 308 feels soft and is intended to feel soft, have some give, and be contoured to the hand, but allows a firm grip of the footboard 304.

Next, kiteboard\footboards typically do not come with a BTLE chip glued in or embedded in. Within this disclosure, the typical installed BTLE mechanism will be referred to as a “BTLE-grain 310”, since the BTLE module therein may be about the size of a grain of rice.

This ends the section on word-usage and semantics.

FIG. 4 shows a footboard 304 in profile view, illustrating an optimal contour of the protruding ridge 308. From FIG. 4 it is apparent that the protruding ridge 308 can have a tapered angle, not “squared off” but instead rather tapered toward the top of the footboard 304.

FIG. 4 also shows an example location of one or more BTLE-grain(s) 310. Variety of locations and quantities the one or more BTLE-grains 310 will be used. It is possible to have more than 1 BTLE-grain 310. It is also possible to locate the BTLE-grain 310 inside of the protruding ridge 308, or to locate the BTLE-grain 310 exterior from the protruding ridge 308. The BTLE-grain 310 is related mostly to the footboard 304, not so much the protruding ridge 308. However, if adding the protruding ridge 308 to an existing footboard 304, that may be a suitable time to also add one or more BTLE-grain(s) 310.

FIG. 4 attempts to show an important feature of the embodiments herein, being amenable to a human hand. The protruding ridge 308 must be quickly findable and have a type of tactile-feedback so that a user's hand can quickly seek it out and not have to look around for it. That is, during actual use, a kiteboarder must react very quickly. Also, their eyes may have other areas that are critical to look at. Thus, the protruding ridge 308 must be finger-sense-able, require not even a quick glace for the human hand to find. FIG. 4 shows how some proportions of the protruding ridge 308 might be arranged, so as to facilitate quick finger-sensing.

A kiteboarder at this advanced level of skill enough to do tricks is typically in a situation where they are doing many things at once, very fast, very instinctively, with their eyes, their hands occupied, their weight concentration fluid (kinetic), and center of gravity fluid, all demanding a lot of attention and quick reaction. Such a state is known among helicopter pilots as being “task saturated”. In such a state, it's likely that very little new information can reach the kiteboarder. That is why the protruding ridge 308 must be quickly findable in a tactile sense. Any add-on kiteboard equipment which forces the kiteboarder to search with eyes, to fiddle about, this likely is unusable. Also, a bolted-on aftermarket handle can become a dangerous weapon.

FIGS. 5 and 6 show example GUIs for an Apple Watch application for use with the embodiments herein. FIG. 5 has a specific button 504 for showing distance from shore.

FIG. 7 shows an example suggested network\electronic topology 700 for various of the IT components associated with the embodiments herein. The electronic topology 700 comprises the cloud 708, an (on-shore) desktop app 712 (optional), some type of beach security 716 (optional), and private/resort security 720 (optional).

Within the footboard itself, the electronic topology 700 further comprises one or more BTLE-grain(s) 310, an emergency GPS beacon 332, and a mobile app 704 (e.g. running on a mobile phone). Although not shown in FIG. 7, from FIG. 3A it is apparent that the kiteboard user may be wearing any of various devices that communicate at least with the wearer's mobile device and mobile app 704, and may also communicate through or directly with the BTLE-grain(s) 310 thus part of the electronic topology 700. These devices may include wrist wearable 320, body wearable 324, and ankle wearable 328.

Within FIG. 7, the protruding ridge 308 is intentionally left out, as not being part of the electronic topology, for not having any electronic or communication capability.

FIG. 8 shows an example four-screen-sequence 800 on the Apple Watch app 724 when the network topology 700 is searching for a lost or missing footboard 304 (via the BTLE-grain(s) 310). The point of FIG. 8 is to show an easily-recognizable moving sequence of shapes that may be quickly glanced at by a wearer of an Apple Watch. The visuality of the four-screen-sequence GUI 804 is likely better and more quickly understood than some type of textual usage.

FIG. 8 is also intended to coney a graphics-minimum type of visual sequence, which loads quickly and does not demand a lot of cloud access or video-refresh and video-processing. The mobile app 704 will be running on a mobile device that may have sketchy access to a cell-tower or any other connection.

FIGS. 9 and 10 shows example GUIs to be displayed on the mobile app 704. FIGS. 11 and 12 show other example Apple Watch GUIs. Some of the imagery used for the Apple Watch app 724 may also be used on the mobile app 704.

### Types of Foams, Application, Aesthetics, Resale

The protruding ridge 308 can use various types of foam and types of adhesives. The protruding ridge 308 could also attach via hook and loop. As such, an embodiment of the protruding ridge 308 could be removed when not doing tricks where it is needed. The protruding ridge 308 could also be machined or molded into the base board during manufacture.

At least two pages of discussion of types of adhesives, types of foams, thicker foam, thinner foam. Also. perhaps not just a foam-stripe, but a foam ‘X’ shape. Differing foam patterns are shown in FIGS. 3B, 3C, 3D, and 3E.

FIGS. 15A-15B-15C show a custom metal applicator 1504 having grates 1508 as a way of applying slow-hardening foam, where that foam is shaped into a protruding ridge 310.

Some foams go on soft, and nicely adhere to where an installer directs it. These then harden into a nice locking surface, that seals off water well. Meanwhile, other types of foams require more steering and directionality, such as foams which harden more slowly.

The system 300 uses foam-combinations that survive water and rain, salt, harsh sunlight. One example is Ethylene-Vinyl Acetate (EVA), an elastomeric polymer that produces materials which are rubber-like in softness and flexibility. EVA has good color-clarity and gloss, and is lightweight yet durable. EVA would be good for aesthetic application in which color-matching is important, sports logos, messages, and other personal touches. Kiteboards are an expression of one's personality, and are also subject to photography. That means the owners may want to customize, re-paint, and re-work their equipment. The embodiments herein strive to accommodate this.

One problem would be the protruding ridge 308 must be unusually strong, as it will be subject to a wide variety of forces and stresses. A removable embodiment of the protruding ridge 308 exists in which a hook-loop connection is made between an anchor-half, likely glued to the board, and a protruding half. However, even then, the anchor-half of the hook/loop must still be securely attached to the footboard 304. It's important that the protruding ridge 308 not ever come off during use.

Next, kiteboarders sometimes sell their boards at 2nd hand, in private sales. Like with guitars, a sticker or a non-factory pattern attached can impact resale price. A buyer may protest, reduce the price due to where the sticker was, due to ruining the color balance. Or complain that the finish (varnish) of the guitar was changed, as the seller removed the sticker but some sticky-glue remained, so the seller than sanded off the sticky-glue. But this sanding leaves a “blank patch” where the varnish was removed also. This also happens when people attach items to their footboard 304.

The intent is to remove completely materials without leaving some sort of residue. Users may remove or sand off the protruding ridge 308 at their convenience. One example occasion might be when the BTLE-grain(s) 310 cease working, or need recharging, assuming the protruding ridge 308 was located to conceal/embed the BTLE-grain(s) 310.

Fortunately, as will be discussed in more detail herein, kiteboarding is an industry that requires high income, requires people that live near water, tends to have a high turnover of goods, with lots of new tends and advancements occurring often. Thus, older kiteboarding equipment can grow obsolete, or at least uncool, very quickly. As such, by the time the BTLE-grain 310 runs out, conks out, gets baked or rendered unusable, the user may already want entirely new equipment anyway.

This ends the section on types of foams.

### Kiteboards and Emergency Rooms

The history of kiteboard injuries includes at least concussions, and/or lost teeth. The soft-padded version of the protruding ridge 308 is carefully formulated to reduce injury. It could help reduce hand injury because if not used, the side rail alone can cut or impact the kiteboarder's hand more easily. As stated, aftermarket bolt-on handles can in rare circumstances become weapons. The embodiments herein take advantage of the fact that a kiteboarding experience is a highly kinetic and unpredictable experience. The embodiments herein thus provide s superior safety advantage over bolt-on handles.

### Safety (Non-Recreation) Features

A safety beacon 332 comprises a back-up mechanism to all the various electronics already on the kite-human-board-cable combo. The safety beacon only has one main function, to help GPS-locate a kiteboard/footboard combination during times of difficulty. The safety beacon 332 does not have a “good news” or recreational purpose, and instead exists strictly to resolve troublesome situations where the kiteboarder may be impaired in some way.

Regarding the 4-part series of FIG. 8, this is to show the user that some processing is occurring, but only the background, so it may not be possible to post the exact details to the screen. The Apple Watch App 724 may be doing some cycling, attempting to find a signal. After a variable period of time, the electronic topology 700 will revert back to using the last known location. As such, the four GUIs of FIG. 8 repeat-in-sequence, while the electronic topology 700 is seeking-seeking-seeking-seeking and <maybe> finding.

The Apple Watch App 724 will use the last known location, but also could do some sort of re-try, according to user configuration, also according to environmental signal issues. The gray-black transitions give a nice visual flow to the Apple Watch wearer, whose visual flow during a boarding experience will be very limited, subject to a lot of distractions and kinetic activity.

Also, another GUI screen exists (not shown), indicating “Jonny Kiteboarder's device NOT FOUND—NOT FINDABLE”. An option would then be to revert to the last known location. In an embodiment, it is possible to note and post a time of when the BTLE or other connection was lost. Between the small size of the BTLE-grain 310, the low-power, and adverse conditions (sun, salt, continual motion, continual rough usage including battering forces and unusual mechanical stresses), BTLE-connectivity is not expected to be perfect.

Along these lines, if the BTLE-grain 310 got kicked, got scraped, got wet, or got damaged in some way. The topology 700 has numerous ways exist to affirm & diagnose “death-of-device, death of footboard 304 and/or BTLE-grain 310”. In other words, the footboard 304 is not responding whatsoever. The embodiments herein acknowledge and accommodate that they are operating in an electronics-hostile environment.

Within the kiteboarding industry, some types of rescue-beacons or rescue-signals do exists, although they are ineffective and highly dependent on the user's mobile device to achieve anything. One example is a satellite phone for safety. These do not work well, and are not meant to be carried on a kiteboard.

To address these and other problems, the embodiments herein have ways to be used to send a S.O.S. text, and could be used as some sort of a beacon to aid in rescue. Or, to warn a loved one “WARNING: Henry is not moving, accelerometer suggests he is holding unusually still for a live Human on a Kiteboard. Henry may be un-conscious”.

Ten years ago, in e.g. 2012, this feature may have been difficult to implement, but body-mounted bio-equipment is getting better, less expensive, more waterproof than ever. Further, battery-management has improved, to the point that a variety of ways exist to determine if a kiteboarder is un-conscious or likely to be in harm.

An ordinary, un-adorned Apple Watch can detect a fall and call 911 if there is no response. However, this feature is known for false positives, even on land. To reduce this problem, the embodiments herein also contain some fall-detection, but specifically modified for kiteboarding. One example might be including Apple Watch screens having a safety feature to auto dial 911 or emergency contact in case of unresponsive detection, with a cancelable countdown timer.

### Testing Environment

In developing various aspects of the topology 700, a test lab exists, including a type of 911 simulator. Except during test, no actual 911 call occurs, instead a fake-911 just for test purposes. Then, later on, recompile with actual 911 coded therein. Avoids false hits, avoids false or spurious 911 calls, avoids butt-dials, instead optimized to trigger only at the appropriate times.

As shown in FIG. 7, the electronic topology 700 may communicate with a person on-land. Perhaps even on a desk-top screen 712. Also can have some type of Jet-Ski paramedic screen (beach security 716, or private/resort security 720), where a lifeguard can Jet-Ski out to a site, with a First Aid kit.

### Business-Model: Kiteboard Safety-Subscriptions, Conferences

Kiteboarders are typically affluent, willing to spend money. Accordingly, kiteboard-amenable business models are emerging. Both kiteboard events, and kiteboard equipment, are getting more complex and more expensive.

Normal 911 calls can in some cases geo-locate someone if the call is made from a properly-enabled mobile phone or even Apple Watch. However, Applicant is contemplating a situation in which specialized beach-security would be needed. A wealthier kiteboarder may pay a subscription $fee in order to belong to some type of kiteboard-safety organization. This would avoid problems of frivolous calling or butt-dial calling of 911.

FIGS. 13 and 14 show two such examples. FIG. 13 shows a racing course 1308 having relay buoys 1304. The relay buoys may pick up the signals from the BTLE-310 where possible, although this may be intermittent. FIG. 14 shows an environment far from shore, to be used by more experienced kiteboarders seeking a more challenging and more difficult experience. Signal relays 1404 are positioned in the deeper waters further from shore, likely on buoys or other fixed mechanism. These signal relay buoys 1404 might communicate with a private/resort security 720 that targets kiteboarders wanting to take higher risks, and willing to pay more money for increased disaster protection.

### Business-Model: Kiteboard Competitions

Competitive Kiteboard Racing exists and is a for-profit business. The embodiments herein can also be used as a way to affirm true performance during a race, and preclude suggestion of cheating or breaking rules. Technology has invaded many aspects of high-revenue high-fan-base sports, including tennis, NFL, NASCAR. Even major league baseball is experimenting with calling balls/strikes using a non-human automated sensor.

### Business-Model: Forced Rescue or Capture

The embodiments herein also anticipate time when kiteboarding is used in a non-recreational context, non-competition context, and/or rescue-context. Let's say something bad is happening off-shore, e.g. 1 mile offshore. Now let's say a dad, an interested party, all he has is a Kiteboard, but he has to get out there to help. Such an unwanted use is discussed merely as a remote example where kiteboards be used in some kind of rescue-context. Further, a trouble-notification-context exists. Where no Jet-Skis are available, and the person only has a choice of either kite out there, or swim out there.

Further, it is possible, although unlikely, that Cubans could use a kiteboard to get across the 90 mile strait between Havana and Key West. Even more strange, a convicted criminal with decent kite-skill may be imprisoned on Rikers Island, or Alcatraz. Or a Papillion situation. Someone could hide a wetsuit, hide a kiteboard near the Island, and a kiteboard may be involved in escape. In 2012 or earlier, such a scenario would have been considered absurd, James-Bond nonsense.

These strange examples, awful as they may be, are meant to show there also exists a context, somehow, some way, where someone would use a kiteboard at night, with no or minimal lighting. Including but not limited to evading law enforcement and/or Border Patrol. The embodiments herein could serve as some kind of tracer or deterrent or rescue/capture context.

### Safety Beacon 332

Moving back to the safety-beacon 332, assume a kiteboarder has dumped, perhaps swallowed some water, got washed out to sea, tangled her cables, could not untangle. The safety-beacon 332 can help such a person, perhaps more than their mobile device 704. That's one thing about a downed kiteboarder. Those various cables and cords can quickly change from helpful mechanical guidance into binding tangle-traps, ways to be tangled on the surface of water. Even worse, in such a case, the kiteboarder is not on-land and thus not having the free and full use of arms, legs, and gravity. The kiteboarder cannot get back up. Typically, where the kiteboarding is over, it's time to go home. However, in this case, the kiteboarder is stuck in the water, and cannot get home.

Further, the BTLE-grain(s) 310 might not be effective at summoning anyone, due to their shorter transmission-distance. FIG. 14 shows an exception to this, in which repeater-buoys 1404 may strategically amplify\rebroadcast BTLE signals at much higher strength.

Separate from the beacon 332, the BTLE-grain 310 does some kind of extra-beaconing. Oddly, despite the task-saturation referred to earlier, some kiteboarders have ability to operate their mobile devices 704 while on their kiteboards. Still, depending on how far they drift out, weather conditions, signal conditions, their mobile devices may not have any signal. To address this, the safety beacon 332 can be auto-activated by certain metrics e.g. body-pulse, body-position, pulsOx, or other detectable circumstance from any of the devices worn or operated by the user (e.g. FIG. 7).

This ends the section on the safety beacon 332.

The following is a non-limiting list of potential kite-shore topologies.
a) yes mobile app 704;
b) no mobile app 704;
c) all communications through iPhone, BTLE-grain 310 not functioning or removed;
d) some communication through BTLE-grain 310 or limited cell-tower access;
e) use existing Apple Watch for accelerometer (& body position), or use wrist-worn device 320 for accelerometer (& body position);
f) BTLE relay buoy 1404 (FIG. 14);
g) safety beacon 332 separate from BTLE-grain(s) 310;
h) safety beacon 332 integrated within BTLE-grain(s) 310;
i) piggyback upon existing ship to shore radio devices or existing lifeguarding electronic communication infrastructure

Within the various topologies described herein, it is necessary for the system 300 to perform BTLE packet management, including for example allocating priority. The BTLE-grain(s) 310 have limited power, and is critical to not overload it. It should now be apparent that the embodiments herein use this BTLE-grain(s) 310 for several different things, of differing priorities. Structure/segment our outgoing packets according to priority/importance. For example, body position of the human, 99% of the time this will be unimportant. Only during a hard fall, head injury, or vertigo, vomiting, and potentially even shark-attack. Body position may\may Not be detected by the wrist-worn device 320 or waist-worn device 324.

The ankle-band 328 can also provide useful context and potential safety information. A real thrill-addict, watching e.g. a competition, may like this body-position information all the time. Or a wife who likes a “ping” every few seconds. If so, user can software-select a “packet upgrade” where body-position data can get higher priority in the outgoing BTLE packets. Higher than other data such as the beacon 332 (FIG. 3A).

The embodiments herein can still broadcast GPS location-info, but “throttle” it in priority, so that location-upgrades come in fits and jerks. Meanwhile, body-position is updated more often. Other way around also. That is, it's possible to upgrade air-temp info, downgrade Jesus-walk detection. Disable Jesus-walk detection. Disable any “height-from water detection” as this is only needed by people who want to collect data on their recreation, not really a needed safety feature or communication feature.

BTLE packet management is an important consideration herein. It is desired to avoid wasting packets, discarding packets, but properly make use of relevant packets, including if necessary performing a type of data-Tetris. Think of this as a type of allocating packet-priority. The expression data-Tetris is intended to convey that only a small data-window is available. Within the kiteboard environment described herein, the BTLE transmission channels do not have a lot of Signal Bandwidth (BW). Can “massage” the data being dispatched by the BTLE-grain 310. Or re-package the data. The BTLE packet format has certain requirements, but data-dispatch could “slice and dice” or in some way. For example, twist, raise, or lower data (like playing packet-Tetris) or truncate data packets in order to be more BTLE-friendly, environment-friendly.

FIG. 16 shows an embodiment of a BTLE-assembly 1608 having a data-packager 1604, or a data-formatter to make the device more BTLE-friendly. This data packager 1604 performs a type of data-twisting or data-Tetris, managing the BTLE packets coming into the BTLE-grains 310 and making them more amenable for usage by the network 700. The BTLE-grain(s) 310 both transmit and receives data, but the data coming from the participating wearable devices 320, 324, 328 from FIG. 3 may be very raw. Thus, some packet-massaging of the BTLE packets can be helpful, such as the data-packager 1604.

Further embodiments include a small inductive chargers for small batteries in salt/brine/sunshine environment (all of which are terrible for small batteries). Another embodiment combines foam-hardening-treatments as a way of embedding electronic devices. These solutions are selected more according to cost more than to their efficiency.

### Test Environment & QOS

The embodiments herein incorporate a number of mechanisms that can affect the QoS as seen by an application receiving BTLE packets from the BTLE-grain(s) 310.

The factors that define application layer QoS typically comprise bandwidth, latency, and error rate. However, for each of these parameters, it is possible to specify limits on variation.

There are clearly many different ways of using the BTLE-grain 310 to optimize one or more QoS parameters. These factors are linked therefore improving one factor may adversely affect another. For example, if zero error rate is required then an infinite latency may result because a packet may be retransmitted indefinitely under adverse radio conditions.

Different BTLE technologies have differing capabilities to offer levels of QoS. The embodiments herein strive to challenge is to specify QoS ranges that can be specified that allows some user-selectability yet still achieves the necessary working capability.

A BTLE transmitter radio can use two types of channel: Connectionless and connection-oriented. Within connection-oriented channels, there are two stream types: Asynchronous and Synchronous.

The system 300 allows an unreliable broadcast mechanism from a master to a number of peripherals. The broadcast packets are not acknowledged by the peripherals; therefore, the master cannot know if the broadcast packet was received by any peripherals. Knowing the outdoor environment of the system 00 is hostile, unreliable broadcast protocol may be used.

A sender may repeat the broadcast to improve reliability. Because of the lack of reliability and the creation of duplicate fragments of data, the use of broadcast is not recommended, and broadcast is generally not used in most BTLE applications. In QoS terms, the connectionless broadcast therefore offers only one direction of data flow, with no QoS guarantee of any sort. Within the system 300, connectionless channels may occur, but their unreliability will be factored into the overall performance of the embodiments herein.

Power saving modes allow devices to be absent from connections, and therefore increase latency and reduce bandwidth in order to conserve power. The use of lower power modes can be negotiated by either sender or receiver at any time during a BTLE connection within the system 100. Each device is responsible for its own power modes, so it is expected that battery powered devices will request low power modes when possible.

SCO and eSCO Packets

In BTLE synchronous packets, a slot at a fixed interval is reserved. In Synchronous Connection Oriented (SCO) synchronous packets there is no retransmission, and if a packet is not received correctly it is dropped. In Enhanced Synchronous Connection Oriented (eSCO) packets there is an optional retransmission window, but only until the next reserved slot.

Synchronous links without retransmission (SCO) give fixed latency, with zero delay variation, but a finite probability of packets are lost.

The main limitation of the QoS model in any radio is that the QoS will be affected by varying radio conditions. For example, latency will vary depending on how many retransmissions are required for a packet.

Some older QoS models are based on Internet usage, not wireless technology, and thus have some limitations. For example, on the Internet, packet loss/delay is largely congestion related, whereas in wireless systems it is due to radio interference.

None of the devices within the system 300 will transmit data in a bursty fashion. All data within the system 300 will be small packets at a low transmission rate.

What is claimed is:

1. A method of manufacturing a footboard for use in a kiteboard system, comprising:
configuring the footboard to have a predetermined contour;
locating an aperture within the footboard;
inserting a BTLE assembly into the aperture; and
attaching to a protruding ridge to the footboard.

2. The method of claim 1, further comprising:
constructing the BTLE assembly to include a data-concentrator, a BTLE grain, and a rechargeable power source.

3. The method of claim 2, further comprising:
the footboard having no existing aperture.

4. The method of claim 2, further comprising:
the footboard being custom-manufactured with the aperture.

5. The method of claim 2, the BTLE-assembly comprising a single BTLE-grain.

6. The method of claim 2, the BTLE-assembly comprising a plurality of BTLE-grains.

7. The method of claim 6, further comprising:
locating one or more BTLE-grains underneath the protruding ridge.

8. The method of claim 6, further comprising:
locating one or more BTLE-grains exterior from the protruding ridge.

9. The method of claim 6, further comprising:
locating a GPS safety beacon in a second aperture within the footboard.

10. The method of claim 9, further comprising:
the kiteboarder having a variety of body-wearable mechanisms, such as wrist-wearable(s), body-wearable(s), and ankle-wearable.

11. The method of claim 2, further comprising:
configuring the protruding ridge with a tapered angle, tapered toward the top of the footboard.

12. The method of claim 11, further comprising:
if adding the protruding ridge to an existing footboard; and
simultaneously add one or more BTLE-grain(s).

13. The method of claim 2, further comprising:
the protruding ridge being finger-sense-able, require no eye-detection for a human hand to find.

14. The method of claim 11, further comprising:
applying the protruding ridge using a custom metal applicator having grates for applying slow-hardening foam;
and shaping the foam is shaped into a protruding ridge.

15. The method of claim 14, further comprising:
formulating the protruding ridge using a foam-combinations that survive water and rain, salt, harsh sunlight.

16. The method of claim 14, the foam-combination comprising Ethylene-Vinyl Acetate.

17. The method of claim 9, further comprising:
incorporating the footboard within an electronic topology comprising a cloud, an (on-shore) desktop app, some type of beach security, and private/resort security.

18. The method of claim 17, further comprising:
enabling the mobile app to communicate with a person on-land on a desk-top screen.

19. The method of claim 18, further comprising:
some type of Jet-Ski paramedic screen e.g. beach security, or private/resort security.

20. The method of claim 19, further comprising:
configuring an environment far from shore, to be used by more experienced kiteboarders seeking a more challenging and more difficult experience;
positioning signal relays in the deeper waters further from shore on buoys; and
repeater-buoys amplifying and rebroadcasting BTLE signals at much higher strength.
